(19) United States
(12) Patent Application Publication
(10) Pub. No.: US 2009/0155554 A1
(43) Pub. Date: Jun. 18, 2009

(54) ENVIRONMENTAL BARRIER COATING AND RELATED ARTICLES AND METHODS

(75) Inventors: Molly Maureen Gentleman, Saratoga Springs, NY (US); Peter Joel Meschter, Niskayuna, NY (US); Yungyee Jennifer Su Saak, Maple Glen, PA (US); Curtis Alan Johnson, Niskayuna, NY (US); Krishan Lal Luthra, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/957,773

(22) Filed: Dec. 17, 2007

(51) Int. Cl. B05D 1/08; B32B 33/00

(52) U.S. Cl. 428/210; 427/446

(57) ABSTRACT

An article resistant to recession in high temperature environments, and methods for making the article, are presented herein. The article comprises a substrate, an intermediate coating system disposed over the substrate, and a topcoat disposed over the intermediate coating system. The intermediate coating system comprises a separator layer comprising an oxygen getter material, and a barrier layer disposed over the separator layer, the barrier layer comprising a ceramic composition. The topcoat also comprises this ceramic composition. Moreover, at least about 50% by volume of the ceramic composition present in the barrier layer is a metastable precursor material that tends to transform over time into a product material. At least about 75% by volume of the ceramic composition present in the topcoat is the product material, and up to about 25% by volume of the ceramic composition present in the topcoat is the metastable precursor material.

### BACKGROUND

This invention relates to high-temperature machine components. More particularly, this invention relates to coating systems for protecting machine components from exposure to high-temperature environments. This invention also relates to methods for protecting articles.

Silicon-bearing materials, such as, for example, ceramics, alloys, and intermetallics, offer attractive properties for use in structures designed for service at high temperatures in such applications as gas turbine engines, heat exchangers, and internal combustion engines, for example. However, the environments characteristic of these applications often contain water vapor, which at high temperatures is known to cause significant surface recession and mass loss in silicon-bearing materials. The water vapor reacts with the structural material at high temperatures to form volatile silicon-containing species, often resulting in unacceptably high recession rates.

Environmental barrier coatings (EBC's) are applied to silicon-bearing materials susceptible to attack by high temperature water vapor, and provide protection by prohibiting contact between the water vapor and the surface of the material. EBC's are designed to be relatively stable chemically in high-temperature, water vapor-containing environments and to minimize connected porosity and vertical cracks, which provide exposure paths between the material surface and the environment. Cracking is minimized in part by minimizing the thermal expansion mismatch between the EBC and the underlying material, and improved adhesion and environmental resistance can be achieved through the use of multiple layers of different materials. One exemplary conventional EBC system, as described in U.S. Pat. No. 6,410,148, comprises a silicon or silica bond layer applied to a silicon-bearing substrate; an intermediate layer comprising mullite or a mullite-alkaline earth aluminosilicate mixture deposited over the bond layer; and a top layer comprising an alkaline earth aluminosilicate deposited over the intermediate layer. In another example, U.S. Pat. No. 6,296,941, the top layer is a yttrium silicate layer rather than an aluminosilicate.

The above coating systems can provide suitable protection for articles in demanding environments. However, cracking, spalling, volatilization, and other mechanisms operating on localized areas of the EBC top layer expose the underlying material—a silicon bond coat, for instance—to the environment, leading to rapid oxidation and volatilization. Once the bondcoat is locally removed by these mechanisms, rapid recession of the underlying silicon-bearing structural component ensues. Recession and perforation of the silicon-bearing component can lead to both component and system failure, as neighboring metallic parts not designed for high temperature service become directly exposed to a corrosive high-temperature environment. Therefore, there is a need to provide articles with robust environmental barrier coating systems that have the capability to reliably withstand long-term exposure to high-temperature environments containing water vapor.

### BRIEF DESCRIPTION

Embodiments of the present invention are provided to address these and other needs. One embodiment is an article comprising a substrate, an intermediate coating system disposed over the substrate, and a topcoat disposed over the intermediate coating system.

The intermediate coating system comprises a separator layer comprising an oxygen getter material, and a barrier layer disposed over the separator layer, the barrier layer comprising a ceramic composition. The topcoat also comprises this ceramic composition.

Moreover, at least about 50% by volume of the ceramic composition present in the barrier layer is a metastable precursor material that tends to transform over time into a product material. At least about 75% by volume of the ceramic composition present in the topcoat is the product material, and up to about 25% by volume of the ceramic composition present in the topcoat is the metastable precursor material.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic cross section of a typical EBC system;

FIG. 2 is a schematic cross section of an embodiment of the present invention; and

FIG. 3 is a schematic cross section of another embodiment of the present invention.

### DETAILED DESCRIPTION

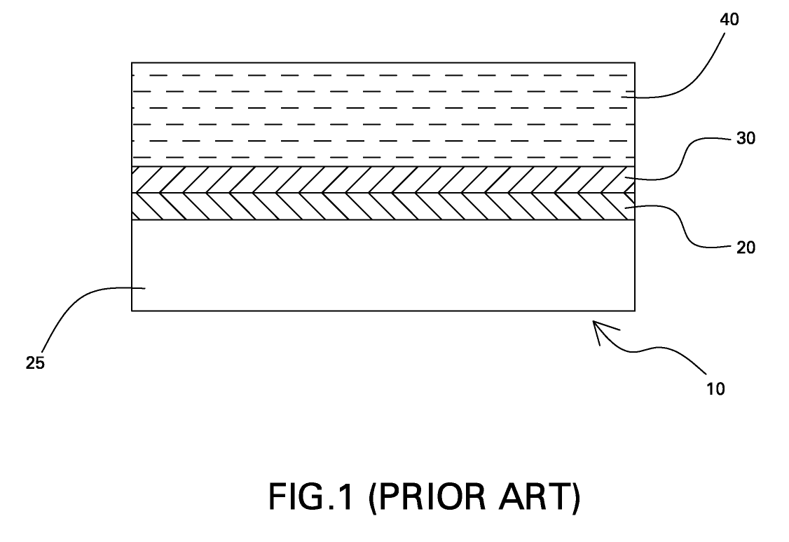

Referring to FIG. 1, a typical EBC system 10 comprises a bondcoat 20 made of silicon applied to a silicon-bearing substrate 25; an intermediate layer 30, deposited over bond coat 20, often made of mullite or a mullite-alkaline earth aluminosilicate mixture; and a top layer 40, often made of an alkaline earth aluminosilicate or other protective ceramic material, deposited over intermediate layer 30. EBC system 10 is highly reliant upon the presence and integrity of top layer 40, because the other layers afford much less environmental protection. As described above, even a relatively small defect in this three-layer coating system can lead to rapid, premature failure of the entire component. Such a failure is a considerable risk because top layer 40, being a ceramic coating, is susceptible to defects in processing and to damage during component installation and service.

Embodiments of the present invention provide enhanced resistance to mechanical damage, such as cracking, due to the presence of layers containing materials that may resist the formation of cracks, or heal existing cracks, much more readily relative to the materials found in systems as described above.

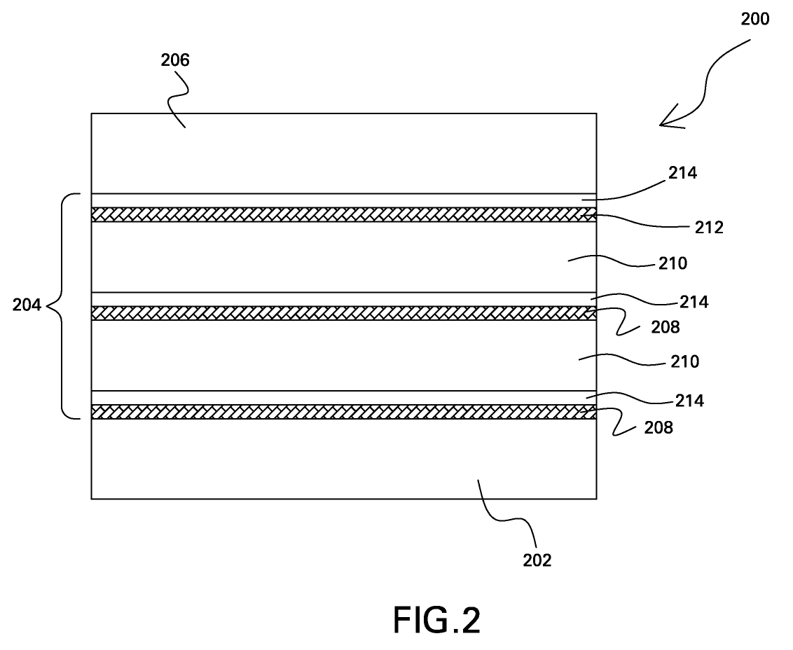

Referring to FIG. 2, one embodiment of the present invention is an article 200 comprising a substrate 202, an intermediate coating system 204 disposed over substrate 202, and a topcoat 206 disposed over the intermediate coating system 204.

Substrate 202 comprises silicon in certain embodiments, including, for example, substrates comprising ceramic compounds, metal alloys, intermetallic compounds, or combinations of these. Examples of intermetallic compounds include, but are not limited to, niobium silicide and molybdenum silicide. Examples of suitable ceramic compounds include, but are not limited to, silicon carbide and silicon nitride. Embodiments of the present invention include those in which the substrate comprises a ceramic matrix composite (CMC) material, including in which the CMC comprises a matrix phase and a reinforcement phase, both of which phases comprise silicon carbide. Regardless of material composition, in some embodiments substrate 202 comprises a component of a turbine assembly, such as, among other components, a combustor component, a shroud, a turbine blade, or a turbine vane.

Intermediate coating system 204 contains multiple layers. A separator layer 208 comprises an oxygen getter material, and serves to inhibit the movement of oxidizing species through the coatings by chemically combining with them and thus binding them before they can arrive at and react with the substrate. As used herein, an “oxygen getter material” means a substance having a high affinity for oxygen atoms or molecules. In certain embodiments, the oxygen getter material comprises silicon. Suitable examples of an oxygen getter material include elemental silicon (including, for example, industrially pure silicon) and a silicide (meaning a compound of silicon and one or more additional chemical elements). The separator layer 208, in some embodiments, has a thickness of up to about 250 micrometers. In certain embodiments, this thickness is in the range from about 50 micrometers to about 150 micrometers, and in particular embodiments, the thickness is in the range from about 80 micrometers to about 120 micrometers. Separator layer 208 in some instances is disposed in contact with substrate 202, where it serves as a traditional bondcoat as that term is understood in the art; thus the term “bondcoat” can be used herein to refer to a “separator layer” that is disposed directly on substrate 202.

Intermediate coating system 204 also includes a barrier layer 210 that comprises a ceramic composition and is disposed over separator layer 208. Barrier layer 210, as that term is used herein, means a coating that is, among other things, designed to provide resistance to recession in high temperature, water-vapor-containing environments, and further to inhibit the penetration of water vapor to underlying layers and substrate. At least about 50% by volume of the ceramic composition present in barrier layer 210 is a metastable precursor material having the tendency to transform over time into a product material. In many ceramic coating systems, this metastable material is an amorphous (glassy) phase with a higher degree of strain compliance than the product material into which it transforms (which may inhibit the formation of cracks during service), or with a sufficiently low viscosity to allow for the material to flow into and at least partially fill defects such as cracks and pores, thereby “healing” accumulated damage to mitigate risks of catastrophic failure.

Barrier layer 210 has a thickness of up to 750 micrometers in some embodiments. In certain embodiments, this thickness is in the range from about 75 micrometers to about 500 micrometers. In particular embodiments, the thickness is in the range from about 75 micrometers to about 125 micrometers. Selection of barrier layer thickness will depend on a number of design considerations, including, for instance, the nature of the expected service environment, the material selected for use as barrier layer 210, and the desired service life.

Topcoat 206 also comprises the ceramic composition found in barrier layer 210, but while the overall chemical makeup of the ceramic composition is the same in both topcoat 206 and barrier layer 210, the constituent phase content of the ceramic composition in these coating layers is somewhat different. For example, as described above, half or more of the ceramic composition volume contained in barrier layer 210 is a metastable precursor material, whereas in topcoat 206, only up to about 25% of the volume is this metastable precursor material. In fact, at least about 75% of the volume of the ceramic composition present in the topcoat is the product material into which the metastable material transforms with time. Thus, the topcoat ceramic composition is primarily made of the more stable phases formed when the metastable phases transform. The topcoat composition is typically selected for recession resistance with suitable erosion and thermal expansion properties to meet design life requirements. The thickness of topcoat 206 is selected in accordance with similar considerations as described above for barrier layer 210, and thus the thickness of the topcoat may be in a similar range of alternatives as described above for the barrier layer 210.

In an exemplary embodiment, the ceramic composition includes an aluminosilicate; that is, a compound or mixture of oxides of aluminum, silicon, and other metal or semi-metal elements. Examples of aluminosilicates include, but are not limited to, barium aluminosilicate, strontium aluminosilicate, and barium strontium aluminosilicate. The metastable precursor material of the barrier layer 210, in some embodiments using aluminosilicate coatings, includes a hexacelsian aluminosilicate phase, an amorphous aluminosilicate phase, or, in some cases, a mixture including these two phase types. These metastable precursor phases are known to transform over time at elevated temperatures to at least a monoclinic celsian aluminosilicate phase. It is this latter phase that, in some embodiments, makes up a significant majority of the aluminosilicate volume in the topcoat, often 80% of the volume or more, and 95% of the volume or more in some embodiments. Monoclinic celsian has a significantly closer CTE match to many silicon-bearing ceramic substrate materials than the metastable hexacelsian phase has.

In some embodiments, as shown in FIG. 2, intermediate coating system 204 comprises a plurality of barrier layers 210, with a separator layer 208 disposed between adjacent members of each pair of barrier layers (in addition, of course, to the barrier layer disposed in contact with the substrate). The use of multiple barrier layers 210 in the intermediate coating system 204 may impart additional compliance and defect tolerance to the overall article 200.

Other layers may be applied to the article 200. In some embodiments, a top separator layer 212 is disposed between the intermediate coating system 204 and topcoat 206. Top separator layer 212, in some embodiments, is accompanied by a transition layer 214 disposed between top separator layer 212 and topcoat 206. Top separator layer 212 comprises an oxygen getter material, in like manner to separator layer 208 described previously, and its thickness may be generally comparable to that of separator layer 208. Transition layer 214 is often applied to limit chemical interactions occurring at an interface. For example, silicon in a separator layer 212 may react with oxygen to form silica. This silica, if in contact with an aluminosilicate coating (such as topcoat 206), may quickly react with the aluminosilicate and further deplete silicon from the separator layer 208, thereby degrading its performance. A transition layer 214 comprising mullite, or barium strontium aluminosilicate mixed with mullite, for instance, may inhibit the deleterious interaction by reducing the amount of aluminosilicate in contact with the silica. For this reason, in some embodiments, a transition layer 214 is disposed between separator layer 208 and barrier layer 210.

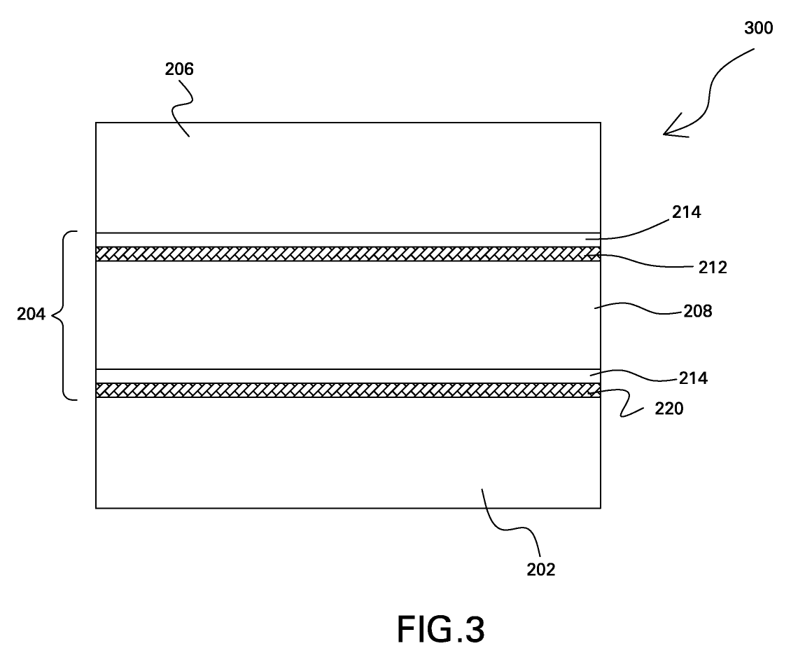

The following exemplary embodiment is provided to further illustrate the above description. Referring to FIG. 3, an article 300 comprises a substrate 202 comprising silicon; a bondcoat 220 comprising elemental silicon or a silicide disposed over substrate 202; an intermediate coating system 204 disposed over bondcoat 220; a top separator layer 212 comprising elemental silicon or a silicide disposed over intermediate coating system 204; and a topcoat 206 disposed over top separator layer 212. Intermediate coating system 204 comprises a barrier layer 208 comprising an aluminosilicate, wherein at least about 50% by volume of the aluminosilicate is hexacelsian barium strontium aluminosilicate, amorphous barium strontium aluminosilicate, or mixtures of the two. Topcoat 206 comprises at least about 80% by volume monoclinic celsian barium strontium aluminosilicate.

As described previously, other coatings may be applied in this exemplary embodiment. In some embodiments article 300 further includes multiple transition layers 214 respectively disposed between the bondcoat 220 and the intermediate coating system 204 and between the intermediate coating system 204 and the topcoat 206. Transition layers 214 comprise mullite, barium strontium aluminosilicate, or mixtures thereof, to limit chemical interactions between the silicon-bearing coatings and the aluminosilicate coatings. In embodiments (not shown) where article 300 comprises multiple barrier layers 210, a separator layer comprising elemental silicon or a silicide is disposed between the adjacent members of each pair of barrier layers, and each separator layer further may be accompanied by a transition layer 214 as described previously.

All of the coatings described herein may be deposited by any of various manufacturing processes, including but not limited to spray processes such as plasma spraying, that have the potential to deposit metastable forms of materials. In an exemplary embodiment, referring again to FIG. 2, a method for manufacturing an article 200 as described above includes providing a substrate 202, disposing an intermediate coating system 204 (including separator layer 208 and barrier layer 210 as described in more detail above) over the substrate, and disposing a topcoat 206 over the intermediate coating system 204. In certain embodiments, the disposition of at least the barrier layer 210 and the topcoat 206 is done by plasma spraying. In the as-deposited condition, barrier layer 210 and topcoat 206 both may contain at least about 50% by volume of the metastable precursor material described previously. In these embodiments, the method further comprises converting the metastable material in the topcoat into the product material. This is often accomplished by heating the material above a transition temperature, such as, for example, a glass transition temperature, for an effective time to allow for the transformation at least partially, and in some cases fully, to occur prior to putting article 200 into service, though in some embodiments the converting step may be performed during service if the service temperature is sufficiently high. In some embodiments, article 200 is heat treated to effect the conversion. Although the entire article, including barrier layer 210, may reach an elevated temperature during this heat treatment step, the conversion of the metastable material to the product material, in some cases, is significantly effected only in the topcoat; the separator layer(s) 208 provide to barrier layer 210 a degree of mechanical constraint and isolation from the environment that significantly inhibits the conversion of metastable material in underlying barrier layer(s) 210.

### EXAMPLE

Without further elaboration, it is believed that one skilled in the art can, using the description herein, utilize the present invention to its fullest extent. The following example is included to provide additional guidance to those skilled in the art in practicing the claimed invention. The example provided is merely representative of the work that contributes to the teaching of the present application. Accordingly, this example is not intended to limit the invention, as defined in the appended claims, in any manner.

An article in accordance with the embodiments described above was fabricated using plasma spray to deposit all coating layers. The substrate was silicon carbide, upon which was deposited a silicon bondcoat, from about 75 micrometers to about 125 micrometers thick. A first transition layer made of a mixture of barium strontium aluminosilicate (BSAS) and mullite, from about 100 micrometers to about 150 micrometers thick, and a barrier layer of BSAS, from about 200 micrometers to about 250 micrometers thick, were deposited over the bondcoat. A silicon separator layer of similar nominal thickness to the bondcoat and a second transition layer of BSAS and mullite of similar nominal thickness to the first transition layer was deposited over the barrier layer, and a topcoat of BSAS, from about 200 micrometers to about 250 micrometers thick was deposited over the second separator layer.

In the as-deposited condition, the BSAS in both the topcoat and the barrier layer was present predominantly in the form of glassy phase. The article was then heat treated in air at a nominal temperature of about 1250 degrees Celsius. This heat treatment converted most of the glassy BSAS material in the topcoat into monoclinic celsian phase, but the glassy phase in the underlying barrier layer remained largely unconverted (though there was some crystallization into the metastable hexacelsian phase), resulting in an article having a compliant barrier layer underlying a topcoat made mostly of monoclinic BSAS.

An article processed as described above was exposed for 500 hours of cyclic steam exposure (250 cycles) in a 90% H2O-10% O2 environment, which has a water vapor partial pressure approximately similar to that of a typical gas turbine. The coating system accumulated minimal damage during this exposure. The separator layer closest to the topcoat was observed to have a thin oxide layer on it, much as would be observed for a similarly exposed silicon bondcoat in a conventional EBC system (FIG. 1). On the other hand, the bondcoat had no oxide layer on it, indicating that the continuous upper separator layer prevented penetration of oxygen and water vapor to the bondcoat.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An article comprising:
a substrate;
an intermediate coating system disposed over the substrate, the system comprising
a separator layer comprising an oxygen getter material, and
a barrier layer disposed over the separator layer, the barrier layer comprising a ceramic composition; and
a topcoat disposed over the intermediate coating system, the topcoat comprising the ceramic composition;
wherein at least about 50% by volume of the ceramic composition present in the barrier layer is a metastable precursor material having the tendency to transform over time into a product material, wherein at least about 75% by volume of the ceramic composition present in the topcoat is the product material, and wherein up to about 25% by volume of the ceramic composition present in the topcoat is the metastable precursor material.

2. The article of claim 1, wherein the intermediate coating system comprises
a plurality of the barrier layers, and
at least one separator layer disposed between adjacent members of each pair of barrier layers.

3. The article of claim 1, further comprising a top separator layer disposed between the intermediate coating system and the topcoat, the top separator layer comprising an oxygen getter material.

4. The article of claim 3, further comprising a transition layer disposed between the top separator layer and the topcoat.

5. The article of claim 1, further comprising a transition layer disposed between the separator layer and the barrier layer.

6. The article of claim 5, wherein the transition layer comprises at least one selected from the group consisting of mullite, barium strontium aluminosilicate, and mixtures thereof.

7. The article of claim 1, wherein the ceramic composition comprises an aluminosilicate.

8. The article of claim 7, wherein the alumino silicate comprises at least one material selected from the group consisting of barium aluminosilicate, strontium aluminosilicate, and barium strontium aluminosilicate.

9. The article of claim 7, wherein the metastable material comprises a hexacelsian aluminosilicate phase, an amorphous aluminosilicate phase, or a combination of hexacelsian aluminosilicate phase and amorphous aluminosilicate phase.

10. The article of claim 7, wherein the topcoat comprises a monoclinic celsian aluminosilicate phase.

11. The article of claim 1, wherein said oxygen-getter material comprises silicon.

12. The article of claim 11, wherein said oxygen-getter material comprises at least one material selected from the group consisting of elemental silicon and a silicide.

13. The article of claim 1, wherein said substrate comprises silicon.

14. The article of claim 13, wherein said substrate comprises at least one selected from the group consisting of silicon carbide and silicon nitride.

15. The article of claim 13, wherein said substrate comprises a ceramic matrix composite.

16. The article of claim 1, wherein said substrate comprises a component of a turbine assembly.

17. The article of claim 16, wherein said component comprises at least one selected from the group consisting of a combustor component, a shroud, a turbine blade, and a turbine vane.

18. An article comprising:
a substrate comprising silicon;
a bondcoat, comprising elemental silicon or a silicide, disposed over the substrate;
an intermediate coating system disposed over the bondcoat, comprising
a barrier layer comprising an aluminosilicate, wherein at least about 50% by volume of the aluminosilicate is hexacelsian barium strontium aluminosilicate, amorphous barium strontium aluminosilicate, or mixtures of the two;
a top separator layer comprising elemental silicon or a silicide disposed over the intermediate coating system; and
a topcoat, comprising at least about 80% by volume monoclinic celsian barium strontium aluminosilicate, disposed over the top separator layer.

19. The article of claim 18, further comprising:
a plurality of transition layers, wherein at least one transition layer is disposed
(i) between the bondcoat and the intermediate coating system; and
(ii) between the intermediate coating system and the topcoat
wherein the transition layers comprise one selected from the group consisting of mullite, barium strontium aluminosilicate, and mixtures thereof.

20. The article of claim 18, wherein the intermediate coating system comprises a plurality of the barrier layers and a separator layer disposed between adjacent members of each pair of barrier layers, the separator layer comprising elemental silicon or a silicide.

21. The article of claim 20, further comprising:
a plurality of transition layers, wherein at least one transition layer is disposed
(i) between the bondcoat and the intermediate coating system,
(ii) between the intermediate coating system and the topcoat, and
(iii) between each separator layer and at least one of its adjacent barrier layers.
wherein the transition layers comprise one selected from the group consisting of mullite, barium strontium aluminosilicate, and mixtures thereof.

22. A method for fabricating an article, comprising:
providing a substrate;
disposing an intermediate coating system over the substrate, the system comprising
a separator layer comprising an oxygen getter material, and
a barrier layer disposed over the separator layer, the barrier layer comprising a ceramic composition; and
disposing a topcoat over the intermediate coating system, the topcoat comprising the ceramic composition;
wherein at least about 50% by volume of the ceramic composition present in the barrier layer is a metastable precursor material having the tendency to transform over time into a product material, wherein at least about 75% by volume of the ceramic composition present in the topcoat is the product material, and wherein up to about 25% by volume of the ceramic composition present in the topcoat is the metastable precursor material.

23. The method of claim 22, wherein disposing the barrier layer comprises plasma spraying the barrier layer, and disposing the topcoat comprises plasma spraying the topcoat.

24. The method of claim 22, wherein disposing the topcoat comprises depositing material comprising at least about 50% by volume of the metastable precursor material, and converting at least a portion of the metastable precursor material into the product material.

25. The method of claim 24, wherein converting comprises heating the precursor material.
